(19) United States
(12) Patent Application Publication
(10) Pub. No.: US 2002/0136872 A1
(43) Pub. Date: Sep. 26, 2002

(54) Lead frame laminate and method for manufacturing semiconductor parts

(76) Inventors: Yoshihisa Furuta, Ibaraki-shi (JP); Norikane Nabata, Ibaraki-shi (JP); Hitoshi Takano, Ibaraki-shi (JP)

Correspondence Address: SUGHRUE MION, PLLC, 2100 PENNSYLVANIA AVENUE, N.W., WASHINGTON, DC, 20037, US

(21) Appl. No.: 10/048,592

(22) PCT Filed: May 30, 2001
(86) PCT No.: PCT/JP01/04563

(30) Foreign Application Priority Data
Jun. 1, 2000 (JP) 2000-164411

(51) Int. Cl. B32B 15/08

(52) U.S. Cl. 428/200; 428/447; 428/450; 257/666

(57) ABSTRACT

A lead frame laminate for use in manufacturing semiconductor parts is provided. A lead frame has an opening and a copper terminal portions formed in the opening. A base material film covers at least the opening and the terminal portions, and laminated on the lead frame through an adhesive layer. The adhesive layer contains a silicone binder and an oxidation inhibitor.

### TECHNICAL FIELD

The present invention relates to a lead frame laminate for use in manufacturing semiconductor parts in which a base material film is laminated on a lead frame having copper terminal portions arrayed around an opening, a method for manufacturing semiconductor parts by use of the lead frame laminate, and an adhesive tape for manufacturing the lead frame laminate.

### BACKGROUND ART

In recent years, attention is given to CSP (Chip Scale/Size Package) technique in the LSI mounting technology. Of the CSP technique, a package represented by QFN (Quad Flat Non-leaded package) or SON (Small Outline Non-leaded package) has a form in which lead terminals are incorporated inside the package so that the terminals are exposed out of the surface of sealing resin.

A general method for manufacturing such a CSP is shown in FIGS. 4A to 4C. That is, electrodes of a semiconductor chip 2 and lead terminals 21b of a lead frame 21 bonded with each other through wires 23 are disposed in a cavity 31 of a lower mold 3. The lower mold 3 is closed by an upper mold 4 through or not though a mold release film 1 (through the mold release film 1 in the illustrated example). Then, resin 5 is injected into the cavity 31 and solidified by transfer molding. Next, after the upper and lower molds are opened, the lead frame 21 is cut by trimming into units with the lead terminals 21b left.

Such resin molding was usually performed by use of a copper lead frame but not through the mold release film 1. Then, the terminal portions were plated with solder after flashes formed in the resin molding and dust adhering to the terminal portions were deflashed. That is, when manufacturing was carried out by use of a lead frame singly, flashes were produced because sealing resin went round to the back surface of the lead frame when the sealing resin was molded. Thus, the sealing resin covered the surface of the terminal portions to be mounted. It was therefore necessary to provide a deflashing step newly to expose the terminal portions. As a result, the number of steps increased so that there were harmful effects: the cost increased; time for manufacturing/delivery was elongated; and so on.

On the other hand, when such resin molding was performed through the release film, there was a certain effect to make the terminal portions exposed. However, it was difficult to prevent flashes over the terminal portions perfectly.

Besides, as a method for manufacturing a semiconductor device, there is known a method as follows (see Japanese Patent Publication No. Sho. 60-224238). That is, an adhesive tape is pasted on the back surface of a substrate having a device hole so as to close the device hole. Next, a device is connected and further sealed with resin. Then, the adhesive tape is peeled off. Thus, the back surface of the substrate is prevented from contamination due to the resin.

When the present inventors tested such application of an adhesive tape to a copper lead frame as described above, however, it was found that resin leakage could be prevented by a silicone adhesive tape which was proof against heating, but the copper lead frame was oxidized by heating. Further, this oxidation increased the quantity of silicone residue adhered to the lead frame when the adhesive tape was peeled off. Thus, uniform solder plating could not be carried out directly on the lead frame. It was therefore necessary to remove silicone before solder plating was performed. Incidentally, if manufacturing is performed on the heating condition that the lead frame is not oxidized, heating can be kept only for a short time. Thus, the manufacturing conditions are subjected to severe restrictions.

On the other hand, investigation was conducted into a method in which heating was performed in nitrogen gas to prevent oxidation. Although the quantity of silicone residue could be reduced, the method could not be regarded as practical in consideration of time, cost and workability necessary for shutting the heated portion tightly, substituting the nitrogen gas for the air, or the like.

### DISCLOSURE OF INVENTION

It is therefore an object of the present invention to provide a lead frame laminate in which a lead frame is restrained from oxidation due to heating even if atmospheric gas is not adjusted, and the quantity of silicone residue is reduced so that it is not necessary to remove the silicone, and to provide a method for manufacturing semiconductor parts and an adhesive tape for a lead frame.

In order to attain the foregoing object, the present inventors made diligent researches into a method for preventing a lead frame from oxidation. As a result, the present inventors found that the foregoing object could be attained by laminating a base material film covering a terminal portion, through an adhesive layer containing an oxidation inhibitor. Thus, the present inventors accomplished the present invention.

That is, according to the present invention, there is provided a lead frame laminate for use in manufacturing semiconductor parts, comprising: a lead frame having a copper terminal portion arrayed around an opening; a base material film covering at least the opening and the terminal portion of the lead frame; and an adhesive layer through which the lead frame and the base material film are laminated; wherein the adhesive layer contains a silicone binder and an oxidation inhibitor.

In the above description, preferably, the adhesive layer contains the oxidation inhibitor in a range of from 0.5 parts to 30 parts by weight with respect to 100 parts by weight of the silicone binder.

Further preferably, in the adhesive layer, the oxidation inhibitor is unevenly distributed in a vicinity of an interface between the adhesive layer and the lead frame.

Still further preferably, the oxidation inhibitor is not dissolved completely but is dispersed in the silicone binder.

On one hand, according to the present invention, there is provided a method for manufacturing semiconductor parts comprising the steps of: molding resin for sealing a semiconductor chip by use of a lead frame having a copper terminal portion arrayed around an opening in the state where a semiconductor chip is connected with the terminal portion; and plating the terminal portion with solder; wherein the base material film along with the adhesive layer are peeled off before the step of plating but after the step of molding by use of a lead frame laminate defined in any one of the above-mentioned items.

On the other hand, according to the present invention, there is provided an adhesive tape comprising a base material film and an adhesive layer for use in manufacturing a lead frame laminate defined in any one of the above-mentioned items.

Features and advantages of the invention will be evident from the following detailed description of the preferred embodiments described in conjunction with the attached drawings.

### BRIEF DESCRIPTION OF DRAWINGS

FIGS. 1A and 1B are views showing an example of a lead frame to which the present invention is applied;

FIG. 2 is a sectional view taken on line I-I in FIG. 1B;

FIGS. 3A to 3C are process views showing an embodiment of a resin molding step according to the present invention; and

FIGS. 4A to 4C are process views showing an example of a conventional resin molding step.

### BEST MODE FOR CARRYING OUT THE INVENTION

An embodiment of the present invention will be described below with reference to the drawings.

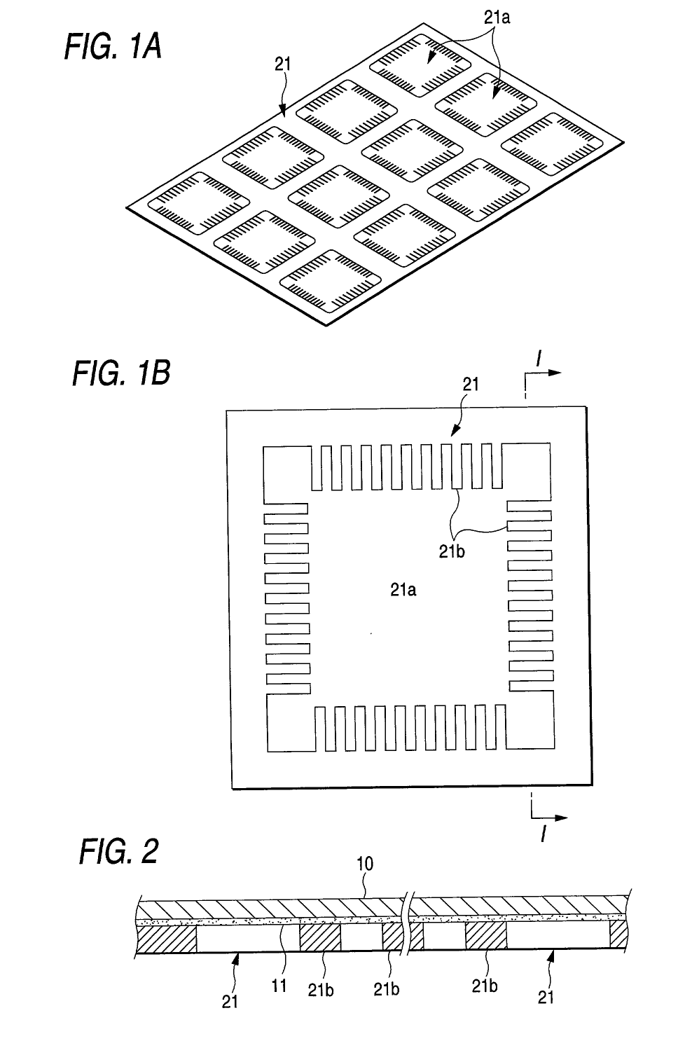

FIGS. 1A and 1B show an embodiment of a lead frame according to the present invention. FIG. 1A is a perspective view showing the lead frame as a whole. FIG. 1B is a plan view showing one unit of the lead frame. As shown in FIGS. 1A and 1B, each lead frame unit 21 (hereinafter simply referred to as “lead frame 21”) has an opening 21a in which a semiconductor chip 2 will be disposed and connected. A plurality of terminal portions 21b are arrayed around the opening 21a. According to the present invention, it will go well if at least the terminal portions 21b are made of copper. However, the lead frame 21 as a whole maybe made of copper.

According to the present invention, the semiconductor chip 2 is electrically connected with the terminal portions 21b through wire-bonding or the like. The semiconductor chip 2 may be connected to the terminal portions 21b after the lead frame is formed into a lead frame laminate. Alternatively, the semiconductor chip 2 may be connected to the terminal portions 21b before the lead frame is not yet formed into a lead frame laminate. Accordingly, the lead frame laminate according to the present invention includes a lead frame laminate having a semiconductor chip 2 connected to the terminal portions 21b in advance.

The terminal portions 21b may have any shape and any array. The shape of each of terminal portions 21b is not limited to a rectangle, but it maybe a patterned shape or a shape with a circular portion. In addition, the array of the terminal portions 21b is not limited to an array in which the terminal portions 21b are disposed all round the opening 21a, but they may be arrayed in any one or plural sides of the opening 21a. For example, the terminal portions 21b may be disposed on a pair of opposite sides of the opening 21a. Anyway, the arrangement manner of the terminal portions 21b is not limited to the specific way.

In the lead frame laminate according to the present invention, the lead frame 21 as described above and a base material film 10 covering at least the opening 21a and the terminal portions 21b of the lead frame 21 are laminated on each other through an adhesive layer 11, as shown in FIG. 2 which is a sectional view taken on line I-I in FIG. 1B. That is, the adhesive layer 11 is put in contact with the lead frame 21 on one surface while the base material film 10 is further laminated on the other surface of the adhesive layer 11 opposite to the one surface which is in contact with the lead frame 21. Thus, the base material film 10 is formed for preventing the adhesive layer 11 from adhering to a mold or the like.

According to the present invention, the lead frame laminate as described above has a feature that the adhesive layer 11 contains a silicone binder and an oxidation inhibitor. Examples of such oxidation inhibitors may include a hindered phenol oxidation inhibitor, a phosphorus oxidation inhibitor, a lactone oxidation inhibitor, etc. These oxidation inhibitors may be used singly or in combination with one another.

Such oxidation inhibitors are often low in compatibility with the silicone binder. For example, if a small quantity of pentaerythrityl-tetrakis [3-(3,5-di-t-butyle-4-hydroxyphenyl) propionate] (trade name: IRGANOX1010) which is a kind of hindered phenol oxidation inhibitor is mixed, the adhesive layer becomes clouded. Thus, usually, such an adhesive layer is regarded as not preferable. However, according to the present invention, it will go well so long as the lead frame can be prevented from oxidation. Therefore, such an adhesive layer not only has no problem, but also rather increases the degree of freedom in selecting the oxidation inhibitor. In addition, the effect of introducing a filler can be expected. Thus, the adhesive property of the adhesive layer can be adjusted by the loading parts of the oxidation inhibitor.

The adhesive layer 11 contains the oxidation inhibitor preferably in a range of from 0.5 parts to 30 parts by weight, more preferably in a range of from 1 part to 15 parts by weight, with respect to 100 parts by weight of the silicone binder. If the oxidation inhibitor exceeds 30 parts by weight, the oxidation inhibitor remains on the lead frame 21 when the adhesive layer 11 is removed. Thus, there is a tendency that the lead frame 21 is contaminated or becomes difficult to be pasted. On the contrary, if the oxidation inhibitor is less than 0.5 parts by weight, there is a tendency that the oxidation preventing effect becomes insufficient. Here, the parts by weight means the ratio of the oxidation inhibitor in the portion where the oxidation inhibitor is present, but it does not have to always include the portion where the oxidation inhibitor is absent.

The adhesive layer 11 may have the oxidation inhibitor unevenly distributed in the vicinity of the interface between the adhesive layer 11 and the lead frame 21. Alternatively, in the adhesive layer 11, an adhesive layer containing an oxidation inhibitor and an adhesive layer containing no oxidation inhibitor maybe laminated on each other. Also in such cases, similar effect can be exhibited. In addition, the oxidation inhibitor may disperse into the silicone binder without perfect compatibility therewith, or may produce bleed or the like.

As the silicone binder, any one used as a silicone adhesive agent is applicable. Various kinds of silicone binders are on the market. There is a silicone binder to which a crosslinker or a catalyst is added to make cross linkage at room temperature or in heating. In the case where such a silicone binder is used, necessary components may be added to the silicone binder and a suitable treatment is carried out for the silicone binder. In addition, a filler such as carbon-nickel or the like may be added to the silicone binder so as to adjust its adhesive property.

The base material film 10 is used as a mask material for preventing the adhesive layer 11 from adhering to a mold or the like. Therefore, a material which is hard to allow the adhesive layer 11 to move toward the back surface of the base material film 10 (for example, a non-porous film) and which has a certain heat resistance so as not to melt when it is heated is preferable as the material of the base material film 10. In addition, when consideration is given to peeling-off/removing of the base material film 10, a material which is hard to be broken or cut is preferable.

Examples of such materials may include filled-up glass cloth; resins such as polyethylene naphthalate (PEN), polyimide (PI), polyphenylene sulfide (PPS), polytetrafluorethylene (PTFE), ethylene/tetrafluorethylene copolymer (ETFE), etc.; various kinds of metal foils (e.g. SUS, aluminum, copper, etc.); and so on. Of these materials, the PI film superior in heat resistance is more preferable.

According to the present invention, it is preferable that the thickness of the base material film 10 is in a range of from 10 μm to 250 μm, and the thickness of the adhesive layer 11 is in a range of from 1 μm to 75 μm.

To manufacture the lead frame laminate according to the present invention, a tape or sheet may be formed in advance in such a manner that the adhesive layer 11 is formed on the base material film 10. Simply by pasting the tape or the sheet formed thus on the lead frame 21, it is possible to obtain the lead frame laminate in a short time and easily regardless of the shape of the lead frame 21. That is, the lead frame adhesive tape having the base material film 10 and the adhesive layer 11 according to the present invention can be used preferably.

Further, if the adhesive layer 11 is formed on the lead frame 21 by coating, the adhesive layer 11 sticks out to the opposite side, that is, toward the surface where an IC chip is mounted, when molding is carried out with sealing resin. Thus, the adhesive layer 11 causes contamination. In addition, it is necessary to provide a mask material correspondingly to the pattern of the lead frame 21. Thus, the adhesive layer 11 lacks the general-use properties. Further, the thickness of the adhesive layer 11 is not uniform so that there is produced a gap between the adhesive layer 11 and the mold when resin is molded. Thus, the gap causes flashes. In addition, if the adhesive layer 11 is formed only on the lead frame 21, the sealing resin swells higher than the terminal portions 21b. Thus, the terminal portions 21b with such swollen sealing resin cannot be mounted in the case in which the terminal portions 21b are to be mounted on a substrate.

Further, when the adhesive layer 11 is applied and formed on the base material film 10, the adhesion between both the base material film 10 and the adhesive layer 11 is improved so that the adhesive layer 11 can be peeled off/removed more surely after the semiconductor part is manufactured. Incidentally, a primer layer or the like maybe provided for enhancing the adhesion between the base material film 10 and the adhesive layer 11.

In addition, the adhesive layer 11 having high adhesion in the interface with the lead frame 21 when the adhesive layer 11 is peeled off is apt to deform a molded semiconductor part when the adhesive layer 11 is removed. Thus, the deformation causes a failure in the semiconductor part. To prevent such a failure, it is preferable that the adhesive layer has an adhesive power of not higher than 4 N/20 mm (according to JIS C2104) with respect to SUS or copper after it is heated at 200° C. for an hour.

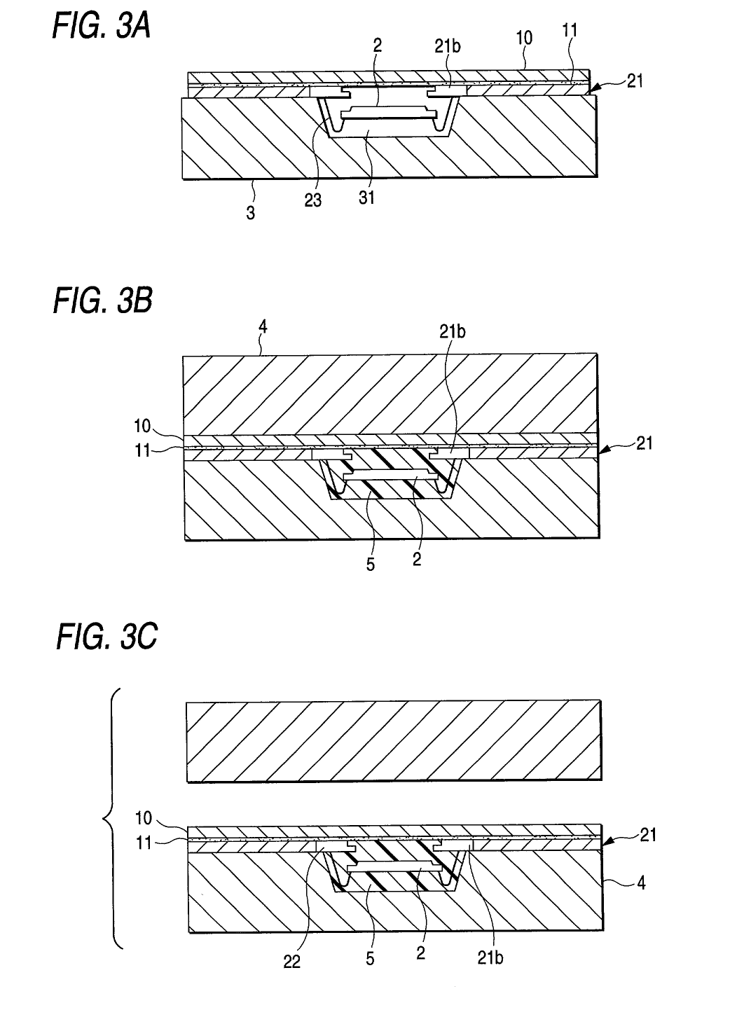

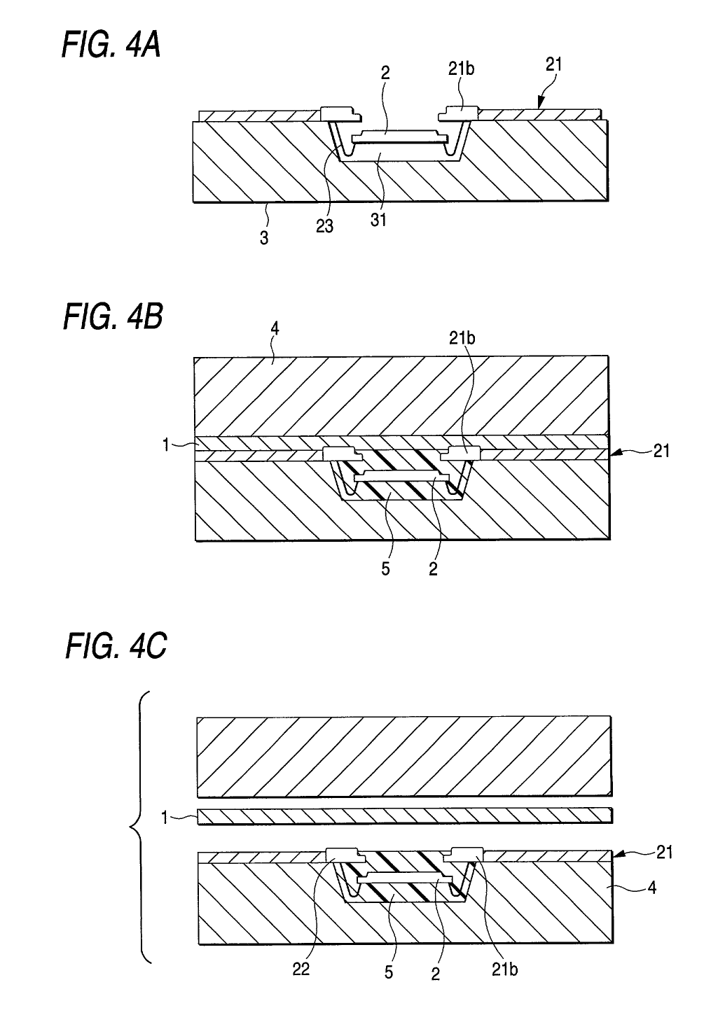

On the other hand, a method for manufacturing semiconductor parts according to the present invention comprises the step of molding resin for sealing a semiconductor part by use of a lead frame having the copper terminal portions arrayed around an opening in the state where the semiconductor chip is connected with the terminal portions (see FIGS. 3A to 3C), and the step of plating the terminal portions with solder. The method for manufacturing semiconductor parts according to the present invention has a feature that a base material film 10 along with an adhesive layer 11 are peeled off before the step of plating but after the step of molding by use of the lead frame laminate according to the present invention.

For example, an adhesive tape formed of the base material film 10 and the adhesive layer 11 in advance is pasted on a lead frame 21 having terminal portions 21b bonded with electrodes of a semiconductor chip 2 through wires 23. Thus, a laminate is obtained. By use of this laminate, as shown in FIGS. 3A to 3C, the semiconductor chip 2 is disposed in a cavity 31 of a lower mold 3. The lower mold 3 is closed by an upper mold 4. Then, resin 5 is injected into the cavity 31 and solidified by transfer molding. Next, the upper and lower molds 3 and 4 are opened. In accordance with necessity, a PMC (Post-Mold Cure) step is carried out in a heater in the state where the adhesive tape is pasted on the lead frame 21. After the adhesive tape is peeled off/removed, a plating step is carried out to plate the terminal portions 21b with solder. After that, or in any suitable time before that, the lead frame 21 is cut by trimming into units with the lead terminals 21b left.

Description will be made below about examples or the like showing the configuration and effect of the present invention specifically.

### EXAMPLE 1

As a silicone binder of an adhesive layer, 100 parts by weight of SD-4587 L, 0.6 parts by weight of catalyst SRX-212 (made by Dow Corning Toray Silicone Co., Ltd.), and 1 part by weight of hindered phenol oxidation inhibitor (IRGANOX1010) were mixed and applied uniformly to form an adhesive layer having a thickness of 30 μm on a polyimide film (KAPTON100 H, 25 μm thick) which was a base material film. This adhesive layer along with the base material film were pasted on a lead frame made of copper. Thus, a lead frame laminate was obtained.

By use of this lead frame laminate, resin molding was carried out on the lead frame at 175° C. for 90 seconds. Then, it was confirmed whether resin burrs (flushes) were produced or not. After that, the base material film was peeled off together with the adhesive layer. Then, it was confirmed whether the lead frame was deformed or not. In addition, the laminate was heated in the air at 175° C. for 7 hours, and then the base material film was peeled off together with the adhesive layer. The Si quantity on the lead frame (unit: g/m² based on the CPS quantity converted by an adhesive agent standard) was confirmed in accordance with X-ray fluorescence analysis.

### EXAMPLE 2

Conditions were set to be similar to those in Example 1, except that the quantity of the hindered phenol oxidation inhibitor (IRGANOX1010) was set to be 5 parts by weight. Thus, a lead frame laminate was obtained, and then the respective estimates were carried out similarly.

### EXAMPLE 3

Conditions were set to be similar to those in Example 1, except that the quantity of the hindered phenol oxidation inhibitor (IRGANOX1010) was set to be 10 parts by weight. Thus, a lead frame laminate was obtained, and then the respective estimates were carried out similarly.

### Example 4

Conditions were set to be similar to those in Example 1, except that IRGANOX1330 was used as the hindered phenol oxidation inhibitor. Thus, a lead frame laminate was obtained, and then the respective estimates were carried out similarly.

### Example 5

Conditions were set to be similar to those in Example 1, except that IRGANOX1331 was used as the hindered phenol oxidation inhibitor. Thus, a lead frame laminate was obtained, and then the respective estimates were carried out similarly.

### COMPARATIVE EXAMPLE 1

Conditions were set to be similar to those in Example 1, except that a lead frame made of copper was used directly in place of the lead frame laminate. Thus, the respective estimates were carried out similarly.

### COMPARATIVE EXAMPLE 2

Conditions were set to be similar to those in Example 1, except that the oxidation inhibitor was not used. Thus, a lead frame laminate was obtained, and then the respective estimates were carried out similarly.

### COMPARATIVE EXAMPLE 3

Conditions were set to be similar to those in Comparative Example 2, except that heating in nitrogen gas substitution was carried out instead of heating in the air at 175° C. for 7 hours. Thus, a lead frame laminate was obtained, and then the respective estimates were carried out similarly.

### COMPARATIVE EXAMPLE 4

Conditions were set to be similar to those in Comparative Example 2, except that the lead frame was replaced by a lead frame of Ni/Pd/Au. Thus, a lead frame laminate was obtained, and then the respective estimates were carried out similarly.

### REFERENCE 1

Conditions were set to be similar to those in Example 1, except that the quantity of the hindered phenol oxidation inhibitor (IRGANOX1010) was set to be 50 parts by weight. Thus, a lead frame laminate was obtained, and then the respective estimates were carried out similarly.

TABLE 1

| | Example | | | | | Comparative Example | | | | Reference |
|---|---|---|---|---|---|---|---|---|---|---|
| | 1 | 2 | 3 | 4 | 5 | 1 | 2 | 3 | 4 | 1 |
| Oxidation | 1 | 5 | 10 | 1 | 1 | — | 0 | 0 | 0 | 50 |
| inhibitor | | | | | | | | | | |
| mp | 150 | | | | | | — | | | |
| compatibility | cloud | | | | | — | transparent | | | cloud |
| flash | no | | | | | yes | | no | | |
| atmosphere | air | | | | | air | | N₂ | air | |
| Si residue | 0.03 | 0.03 | 0.03 | 0.3 | 0.1 | ND | 2.5 | 0.01 | 0.08 | note 1 |

| | |
|---|---|
| deformation | no |

note 1: Little adhesion, hard to paste on the lead frame.

In Table 1, “mp” means “melting point” and “ND” means “not detective”.

As shown in the results of Table 1, it is apparent that, by forming the lead frame laminate in which an adhesive layer containing an oxidation inhibitor is laminated, the Si residue in each of Examples 1 to 5 can be reduced to 1/100 to 1/10 of that in Comparative Example 2 where there is no oxidation inhibitor in the air. Thus, it is apparent that a molded product equal to that obtained in not-oxidizing nitrogen gas in Comparative Example 3 can be also obtained in each of Examples 1 to 5, or a molded product equal to that obtained by use of a Ni/Pd/Au lead frame (which cannot be oxidized) in Comparative Example 4 can be also obtained in each of Examples 1 to 5. In addition, it is also apparent that flashes are prevented in each of Examples 1 to 5.

For example, in view of these facts described in Examples 1 to 5, not only in the resin molding step but also in the PMC (Post-Mold Cure) step in which the lead frame is usually heated at 175° C. for 5 to 7 hours, the silicone residue can be reduced and the lead frame can be heated in the form of the lead frame laminate. Thus, dust can be prevented from adhering to the terminals.

### INDUSTRIAL APPLICABILITY

In the lead frame laminate according to the present invention, as shown in the results of the examples, an adhesive layer containing an oxidation inhibitor covers a terminal portion so that the progress of oxidation is delayed even if the lead frame laminate is heated in the air. As a result, the quantity of silicone residue is reduced so that the terminal portion can be plated with solder easily. In addition, a silicone binder contained in the adhesive layer does not deteriorate on a large scale in a semiconductor manufacturing step in which the silicone binder is heated at about 200° C. for several hours. Thus, flashes of sealing resin can be prevented by the adhesive layer. Further, a base material film is laminated on the lead frame through the adhesive layer so as to cover at least the opening and the terminal portion of the lead frame. Thus, there can be obtained a mold release effect or the like.

When the adhesive layer contains the oxidation inhibitor in a range of from 0.5 parts to 30 parts by weight with respect to 100 parts by weight of the silicone binder, the oxidation preventing effect is enhanced more while the tackiness of the adhesive layer can be improved more.

In addition, when the oxidation inhibitor in the adhesive layer is unevenly distributed in the vicinity of the interface between the adhesive layer and the lead frame, the oxidation preventing effect is exhibited more effectively. Thus, the oxidation preventing effect can be obtained with a small quantity of the oxidation inhibitor. Incidentally, the silicone binder itself has a low necessity for the oxidation inhibitor.

On one hand, in the method for manufacturing semiconductor parts according to the present invention, a molding step is performed by use of the lead frame laminate according to the present invention. As a result, by the above-mentioned operation/effect, the lead frame is restrained from oxidation due to heating even if the atmospheric gas is not adjusted. Thus, the quantity of silicone residue is reduced so that it can be made unnecessary to remove the silicone. In addition, for example, a PMC (Post-Mold Cure) step is performed in the state where the base material film and the adhesive layer are pasted on the lead frame. Thus, the base material film and the adhesive layer are peeled off just before a plating step is carried out. In this case, it is possible to preferably prevent dust from adhering to the terminal portion.

On the other hand, in the adhesive tape for the lead frame according to the present invention, it is possible to easily obtain a lead frame laminate having the above-mentioned operation/effect only by pasting the adhesive tape on the lead frame.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

1. A lead frame laminate for use in manufacturing a semiconductor part, comprising:
a lead frame having an opening and a copper terminal portion formed in said opening;
a base material film covering at least said opening and said terminal portion; and
an adhesive layer through which said lead frame and said base material film are laminated;
wherein said adhesive layer contains a silicone binder and an oxidation inhibitor.

2. A lead frame laminate according to claim 1, wherein said adhesive layer contains said oxidation inhibitor in a range of from 0.5 parts to 30 parts by weight with respect to 100 parts by weight of said silicone binder.

3. A lead frame laminate according to claim 1, wherein in said adhesive layer, said oxidation inhibitor is unevenly distributed in a vicinity of an interface between said adhesive layer and said lead frame.

4. A lead frame laminate according to claim 1, wherein said oxidation inhibitor is not dissolved completely but is dispersed in said silicone binder.

5. An adhesive tape for use in manufacturing a lead frame laminate in which a lead frame has an opening and a copper terminal portion formed in said opening, said adhesive tape being able to be pasted on said lead frame so as to cover at least said opening and said terminal portion to thereby manufacture said lead frame laminate, said adhesive tape comprising:
a base material film; and
an adhesive layer formed on said base material film, and containing a silicone binder and an oxidation inhibitor.

6. An adhesive tape according to claim 5, wherein said adhesive layer contains said oxidation inhibitor in a range of from 0.5 parts to 30 parts by weight with respect to 100 parts by weight of said silicone binder.

7. An adhesive tape according to claim 5, wherein in said adhesive layer, said oxidation inhibitor is unevenly distributed in a vicinity of an interface between said adhesive layer and said lead frame.

8. An adhesive tape according to claim 1, wherein said oxidation inhibitor is not dissolved completely but is dispersed in said silicone binder.

9. A method for manufacturing a semiconductor part comprising steps of:
preparing a lead frame having an opening and a copper terminal portion formed in said opening;
preparing an adhesive tape comprising a base material film, and an adhesive layer formed on said base material film and containing a silicone binder and an oxidation inhibitor;
pasting said adhesive tape on said lead frame to thereby cover at least said opening and said terminal portion;
connecting a semiconductor chip with said terminal portion;
molding resin for sealing said semiconductor chip in a state where said semiconductor chip is connected with said terminal portions;
peeling off said base material film and said adhesive layer after the molding step; and
plating said terminal portion with solder after the peeling-off step.
